(19) United States
(12) Patent Application Publication
(10) Pub. No.: US 2009/0215018 A1
(43) Pub. Date: Aug. 27, 2009

(54) Remote Observation System and Method of Use

(75) Inventors: Richard Shawn Edmondson, Logan, UT (US); Thomas Anthony Shuster, North Logan, UT (US); Clint Brent Eliason, Logan, UT (US); Seth Richard Johnson, North Logan, UT (US); Andrew Newell, Brighton (GB)

Correspondence Address: INNOVATIVE WORKS, LLC, 1907 NORTH 1380 EAST, NORTH LOGAN, UT, 84341, US

(73) Assignee: thereNow, Inc., North Logan, UT (US)

(21) Appl. No.: 12/202,369

(22) Filed: Sep. 1, 2008

Related U.S. Application Data
(60) Provisional application No. 61/031,675, filed on Feb. 26, 2008.

(51) Int. Cl. G09B 5/14; H04N 7/18

(52) U.S. Cl. 434/308; 348/143; 348/E07.085

(57) ABSTRACT

The system enables the observer(s) to record video and audio received from the remote location. The systems and methods enable the capture, storage, and management of metadata linked to the observation video and audio. The systems and methods enable communication between users and enables sharing of metadata. The systems and methods enable the immediate sharing of metadata and performance feedback between the observer(s) and the observed. The systems and methods also allow for delayed sharing of metadata and performance feedback. The systems and methods use technology to overcome the barriers of distance, enabling feedback that occurs in context, with high frequency, distributed over time and that is individualized. The system manages the presentation of all data types to the users. The system can also manage the scheduling of people and resources allocated to the systems and methods implementation.

### RELATED APPLICATIONS

This application claims the benefit of co-pending U.S. Provisional Patent Application Ser. No. 61/031,675, filed on Feb. 26, 2008.

### FIELD OF THE DISCLOSURE

This disclosure relates to technology-assisted observation systems and methods and, more particularly, to systems and methods that enable cognitive apprenticeship.

### BACKGROUND

Technology-assisted observation (e.g. video conferencing, computer-assisted methods) has been used in observation, training and research. However, current systems lack the ability to interact in a manner suitable for cognitive apprenticeship. Systems that support cognitive apprenticeship require a number of capabilities including: a) monitoring and/or recording of trainee during performance in an actual location of primary engagement; b) unobtrusive observation to enable performance in a natural setting; c) observation in real time by remote trainer; d) ability to capture and save meta-data about the observation; e) ability to provide feedback to trainee in immediate or close time proximity to suggest corrective actions; f) security of transmitted data; and, g) a mobile system not linked to a particular site of installation.

Cognitive apprenticeship is a system or method that brings tacit physical and cognitive processes into the open where learners can observe, enact, and practice these processes with help from the teacher or expert. In essence cognitive apprenticeship involves: a) modeling of physical and cognitive processes by the teacher or expert,: b) observation by the teacher or expert of these processes being enacted by the learner, and c) communication between the teacher or expert and the learner about the enacted processes.

Research clearly indicates that cognitive apprenticeship is a highly effective method in transferring skills and knowledge to learners [e.g. Collins, Brown & Newman, Cognitive Apprenticeship: Teaching the craft of reading, writing, and mathematics, Technical report: Center for the Study of Reading, University of Illinois, 1987; R. Shawn Edmondson. Evaluating the effectiveness of a telepresence-enabled cognitive apprenticeship model of teacher professional development, Doctoral Dissertation, Utah State University, 2006]). Cognitive apprenticeship is most effective when its components (i.e. modeling, observation, and communication) occur in realtime, in context, with high frequency, are distributed over time, and are individualized for the learner.

Methods of implementing cognitive apprenticeships without technology are inefficient as a result of constraints such as geographical distances between the learner and expert, time required for travel, and the expenses required to overcome these barriers. Technology-based systems overcome these barriers and allow the expert and learner to interact in a manner consistent with the characteristics of cognitive apprenticeship.

Both security-camera and video-conferencing technologies allow one to observe remote locations, respond to observed conditions, and allow for two-way communication. However, neither video conferencing systems nor security-camera systems are specifically configured to enable the interactions required for cognitive apprenticeship.

### SUMMARY

These technology-assisted observation systems and methods enable cognitive apprenticeship. The hardware observation platform is mobile, i.e. it can be easily moved within and between buildings. It can be physically moved by local manipulation (e.g. pushing) or by mechanical remote control.

In one embodiment video is captured and transmitted by and to one or more devices that enable the observer(s) to see activity in a remote location. In one embodiment, the transmission could be captured and transmitted to one or more observers in one or multiple locations. The camera functions (e.g. pan, tilt, zoom movements, light settings) are remote controlled. One embodiment uses an AXIS 214 PTZ to capture video. The audio is captured and transmitted by one or more devices that enable the observer(s) to hear activity in the remote location. The audio device functions (e.g. volume, bit rate) are remotely controlled. One embodiment uses an AXIS 214 PTZ and VOIP to capture audio. The system enables the observer(s) to record video and audio received from the remote location.

Metadata is “data about data”, of any sort in any media. An item of metadata may describe an individual datum, or content item, or a collection of data. Metadata may provide context for data. Metadata is used to facilitate the understanding, characteristics, and management usage of data. The role played by any particular datum depends on the context. One form of Metadata is data generated about the observation. The systems and methods enable the capture, storage, and management of metadata linked to the observation video and audio. One embodiment uses time-stamped open-ended text notes, time-stamped closed-ended observations protocols, and audio and/or video notations that may be presented inline. Inline means that text, audio, and audio/video notations are represented and/or presented on the video timeline.

The systems and methods enable communication between users and enables sharing of metadata. One embodiment is the VOIP phones. The systems and methods enable the immediate sharing of metadata and performance feedback between the observer(s) and the observed. The systems and methods also allow for delayed sharing of metadata and performance feedback. The systems and methods use technology to overcome the barriers of distance, enabling feedback that occurs in context, with high frequency, distributed over time and that is individualized. One embodiment uses Virtual Private Network, SSL, and VOIP encryption. User authorization is controlled using authentication and role-based logins. One embodiment uses a database of verified users whose roles and access have been defined. The user's access to data in the system is limited by their roles. Users access the systems through a login procedure. Based on their login users are given access to observation data, provided the controls for the audio, video, and mobility and the capture of metadata. The system manages the presentation of all data types to the users. The system can also manage the scheduling of people and resources allocated to the systems and methods implementation.

The foregoing and other features and advantages will become more apparent from the following detailed description, which proceeds with reference to the accompanying figures.

### BRIEF DESCRIPTION OF THE DRAWINGS

Although methods and materials similar or equivalent to those described herein can be used in the practice of the present disclosure, suitable methods and materials are described herein. The materials, methods, and examples are illustrative only and not intended to be limiting.

FIG. 1. An example is shown of an observation method of an observer at remote receiving station observing a subject and providing feedback through the remote receiving station.

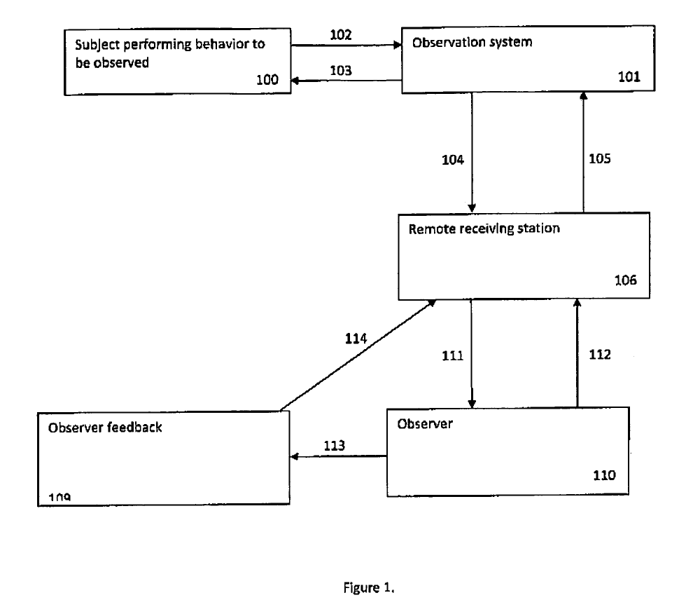

FIG. 2. An example is shown of an observation method of an observer at remote receiving station observing a subject providing feedback through an independent audio link.

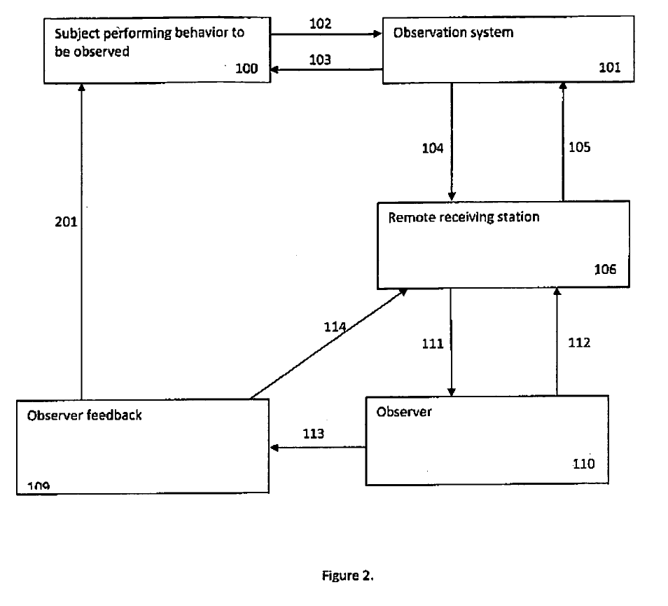

FIG. 3. An example is shown of an observation method of an observer at remote receiving station observing a subject providing feedback while observation data and metadata are recorded by the observer.

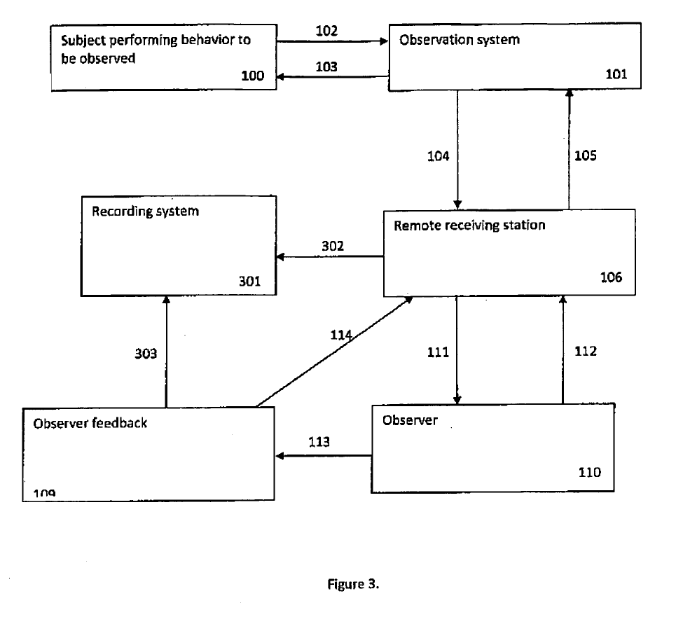

FIG. 4. An example is shown of a training method of trainer at a remote location from the trainee location providing instruction through the receiving station with trainee providing comments or questions through the remote receiving station.

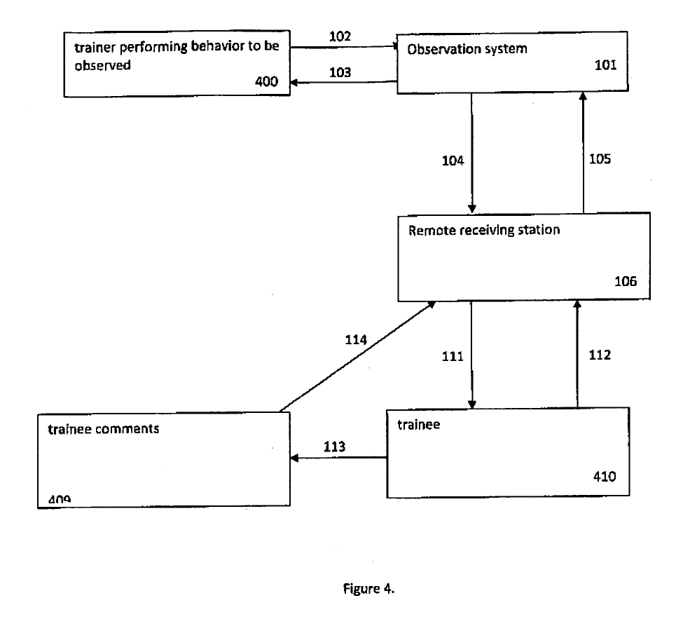

FIG. 5. An example is shown of a training method of a trainer at a remote location from the trainee location providing instruction through the receiving station with trainee providing comments or questions through an independent audio link.

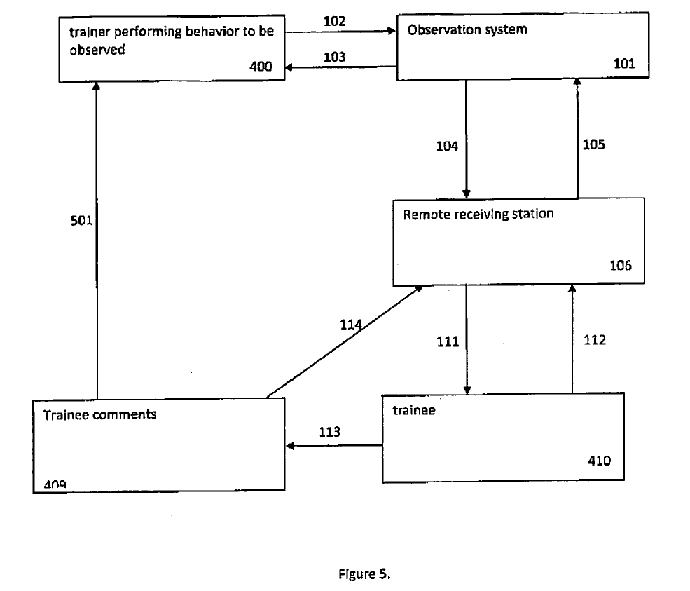

FIG. 6. An example is shown of a training method of trainer at a remote location from the trainee location providing instruction through the receiving station with trainee providing comments or questions while observation data and metadata are recorded.

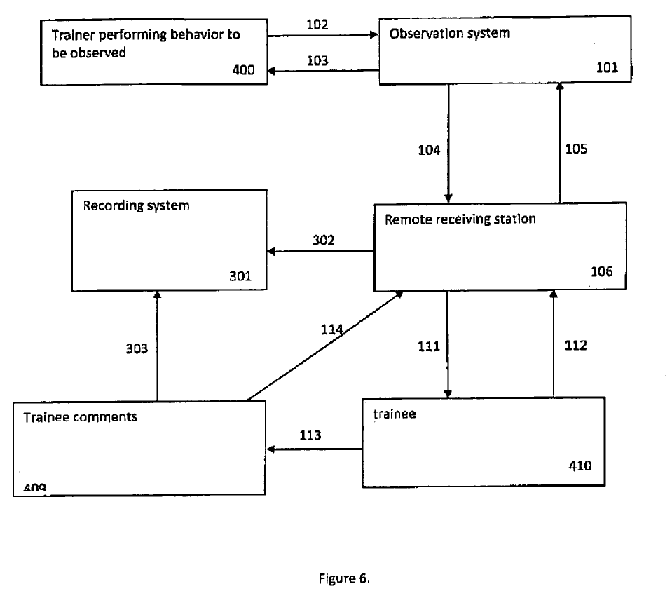

FIG. 7. An example system diagram is shown of the observation node and remote receiving station.

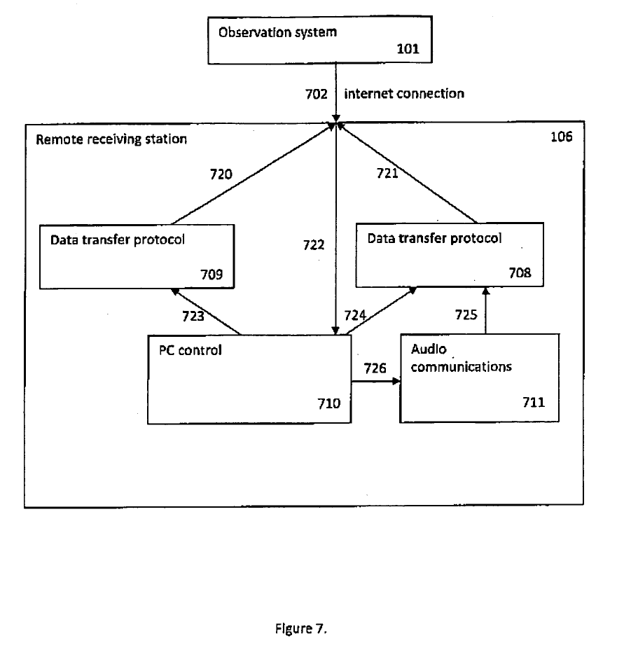

FIG. 8. Representative example observation modes of operation of the system for one to one and one to multiple configurations.

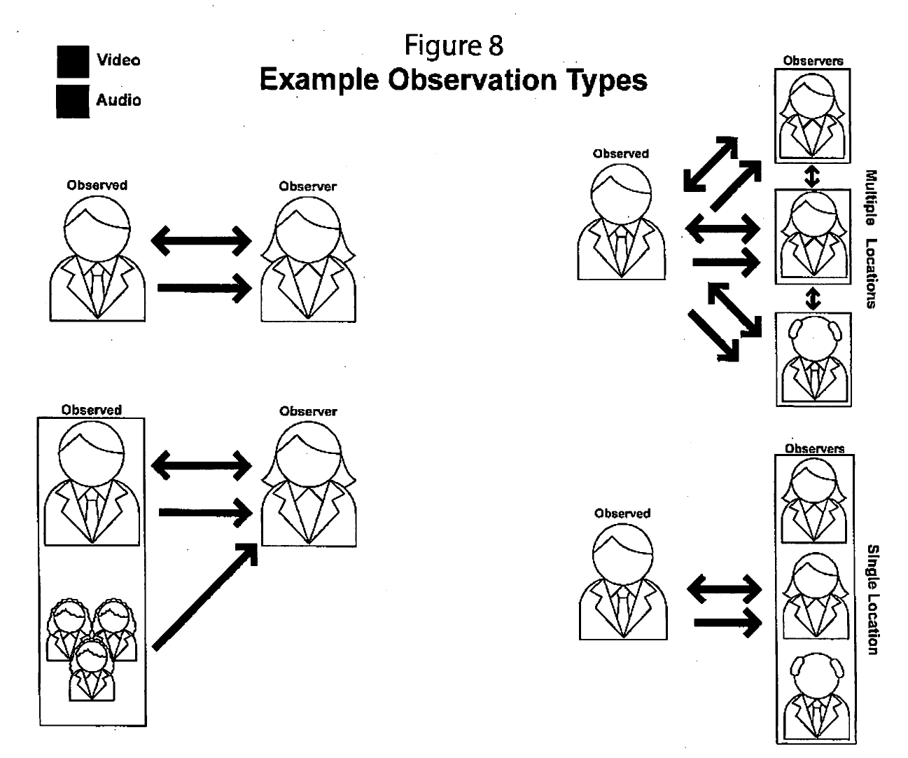

FIG. 9. Example mobile observation system.

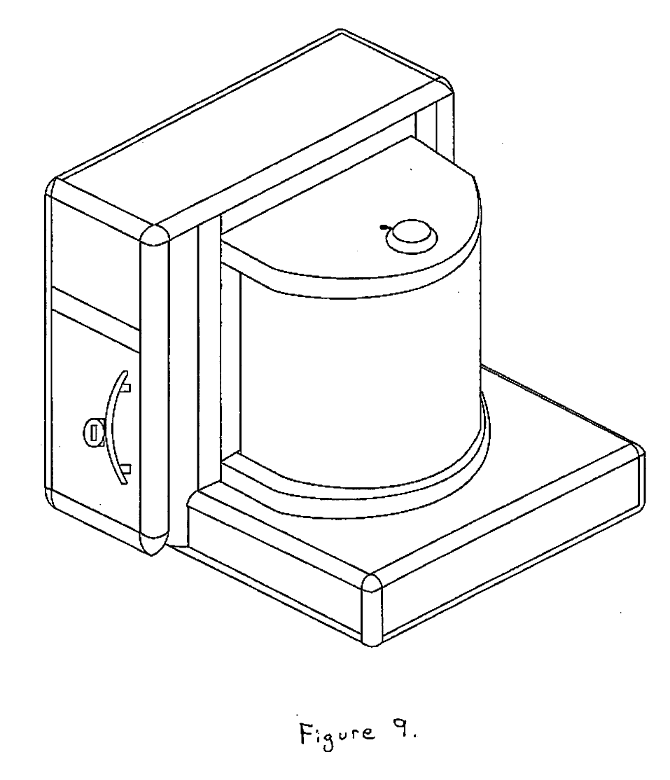

### DETAILED DESCRIPTION

In view of the many possible embodiments to which the principles of the disclosure and examples may be applied, it will be recognized that the illustrated embodiments are only examples of the invention and are not to be taken as limiting its scope.

The following detailed description of exemplary embodiments of the invention makes reference to the accompanying drawings, which form a part hereof and in which are shown, by way of illustration, exemplary embodiments in which the invention may be practiced, the elements and features of the invention are designated by numerals throughout. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

Unobstrusiveness. To enable cognitive apprenticeship-based learning in many situations the subject needs to be observed performing the behaviors without the interference that an onsite observer would add. For example, a teacher in a classroom would suffer interference if the students saw an unfamiliar observer in the classroom. Further disruption of the students and thus the teaching process would ensue if the observer was seen communicating with the teacher. The present invention enables an observer-observed (or observers-observed) relationship to be established without disruption of the subject process being observed. The unobtrusive nature of the observation enabled by the invention would lead to greater scientific validity and reliability of the metadata about the observed behavior. The resulting metadata would be more useful for its purposes as a result of the increased scientific validity and reliability.

For example, in a classroom embodiment the unobtrusiveness of the in-classroom portion of the system is considered in the design. The in-classroom device is purposely small; the color of the materials is chosen to not draw attention to the device; as a result of a darkened shield, movement of the camera cannot be observed by in-classroom participants; and the noise level of the operating device is low to minimize disruption caused by operation of the in-classroom device.

Feedback. The systems and methods provide for feedback in a continuum of timeframes. Feedback to the observed can be given in real time while the subject of the observation is performing the behavior to be observed. A further use of the system is to provide a means to record the observed subject along with time correlated metadata. This recording serves as additional material for cognitive apprenticeship, background data for further encounters, a means for measuring progress of the observed and as security means to ensure proper and legal use of the observation process. The systems and methods enable feedback as close to the performance as practical—in some cases this will be immediate and in other cases it may be delayed as defined by the application.

The observation is accomplished using a hardware observation platform (101). This platform may be mobile to allow for observation of multiple sites or multiple locations within a site. This allows the observation system to be brought to the normal venue of the observation, enhancing its effectiveness for cognitive apprenticeship. The observation system (101) video is captured and transmitted (104) by one or more devices (106) that enable the observer (110) Docket No. 08001 or observers to see activity in the observation area. The device functions (e.g. pan, tilt, zoom movements, light settings) can be remotely controlled (105). The audio is captured (101) and transmitted (104) to the remote receiving station (106). In one embodiment the system enables the observer or observers to record video and audio (301) received from the remote location. Metadata is data generated about the observation (109). The system and methods enables the capture (303), storage (301) and management of metadata linked to the observation video and audio. One embodiment uses time-stamped open-ended text notes, time-stamped closed-ended observations protocols, and audio and/or video notations that may be presented inline. These metadata can be generated by a single observer or by multiple observers. These metadata can be added during the observation or could be generated asynchronously by the single observer or by multiple observers.

Other data can be gathered involving measuring a subject's quantifiable bodily functions such as blood pressure, heart rate, skin temperature, sweat gland activity, and muscle tension. Some of these data allow for understanding of the subject's unconscious physiological activities. In addition to the audio and visual data already discussed other types of data that could be monitored include, but are not limited to: Electromyograph, Thermometer, Electrodermograph, Electroencephalograph, Photoplethysmograph, Pneumograph, Capnometer and Hemoencephalography.

An electromyograph typically uses electrodes in order to measure muscle action potentials. These action potentials result in muscle tension. A thermistor or other temperature sensitive device attached to the subject's digits or web dorsum measures the subject's skin temperature. An electrodermograph sensor measure the activity of a subject's sweat glands. An electroencephalograph monitors the activity of brain waves. Photoplethysmographs are used to measure peripheral blood flow, heart rate, and heart rate variability. A pneumograph measures abdominal/chest movement (as when breathing), usually with a strain gauge. A capnometer measures end-tidal CO2, most commonly with an infrared detector.

Hemoencephalography is a method of functional infrared imaging that indirectly measures neural activity in the brain. There are two known types, passive infrared and near infrared. Near infrared measures the differences in color of light reflected back through the scalp, based on the relative amount of oxygenated and unoxygenated blood in the brain. Passive infrared measures the amount of heat that is radiated by the scalp at various locations of interest.

The systems and methods enable communication between users (114, 201) and enables sharing of metadata (109, 409). The systems and methods enable the immediate sharing of metadata and performance feedback (114, 201) between the observer or observers and the observed. The systems and methods also allow for delayed sharing of metadata and performance feedback (301). The systems and methods use technology to overcome the barriers of distance, enabling feedback that occurs in context, with high frequency, distributed over time, and that is individualized.

Control of the systems (710) and methods is implemented using a computer or equivalent such as a server, laptop, desktop, a computer with single or multiple CPUs, and/or embedded CPU. The computer controls user access to observation data (709), provides the controls for the audio, video, and mobility (708) and enables the capture of metadata and manages the interaction between users (722). The computer (710) manages the presentation of all data types to the users. The computer (710) can also manage the scheduling of the people and resources allocated to the systems or methods implementation.

Physical security of the hardware observation platform (101) is achieved by using construction techniques that make access to the electronic components within the platform very difficult. One embodiment utilizes construction techniques that require specialized tools to open the housing of the device. Forcibly breaking into the device to access the electronics is deterred by rugged construction materials such as plastics and aluminum bolted and screwed together such that they are extremely difficult to break apart or into. Additional means of physical security could include requirement of a physical key to unlock access or unlock operation of the electronics, a digital key to enable operation of the electronics or a combination of security means. Other physical security means are known to those skilled in the art and could be implemented without departing from the spirit and scope of the present invention. The description of the embodiments of the present invention is not intended to limit the scope of the invention but is presented for purposes of illustration only and not limitation to describe the features arid characteristics of the present invention.

The security of data transmission (104) from the electronic components within the hardware platform to the remote operator is achieved by using encryption (709). One embodiment uses a virtual private network (VPN) appliance (such as Netgear PROSAFE® DUAL WAN VPN FIREWALL WITH 8-PORT 10/100 SWITCH FVX538) that creates an encrypted “tunnel” through the public internet from the electronic components to the remote operator. These data are highly unlikely to be intercepted and/or decrypted and are therefore very secure. Another means of data transmission security is to utilize a secure dedicated transmission line. Another means of data security is to utilize an encoded wireless connection requiring validation of the sender and user sites. Other data transmission security means are known to those skilled in the art and could be implemented without departing from the spirit and scope of the present invention. The description of the embodiments of the present invention is not intended to limit the scope of the invention but is presented for purposes of illustration only and not limitation to describe the features and characteristics of the present invention.

Remote operators (110, 410) of the electronic components are authorized using assigned passwords and logins stored in a secure database. Logins are associated with roles that define and limit users' access. Those skilled in the art could implement password protected logins in a secure database with associated permissions assigned according to predetermined roles without limiting the features and characteristics of the present invention.

In one embodiment, the observation and transmission hardware platform (101) is physically small, light, and manageable enough that it can be easily moved by a single individual within and between deployment sites (e.g. between classrooms within a school or between schools or between places of business). One embodiment includes a hardware platform that is approximately 12″×12″×20″ and has a handle and shoulder strap so that the device can be carried. This particular form factor is very mobile and is designed to be able to be hung on a wall, placed on a shelf, desk, or other object to give it the height to enable effective observation. Another embodiment is a hardware platform that is 28″ in diameter at the base and 6′ tall and wheeled. This platform is much larger but still mobile within and between sites and does not require placement on another object to achieve a higher observation point.

Video is captured (101) and transmitted (104, 702) at a sufficient quality (e.g., resolution and frame rate) to enable image quality suitable for accurate site observation. One embodiment uses the AXIS 214 Pan, tilt, zoom, IP-addressable security camera. This camera produces images with a resolution of 704×576 pixels PAL, 704×480 NTSC and has an 18× zoom capability. It also enables network security (709) using multiple user access levels, IP address filtering, HTTPS encryption and IEEE 802.1X authentication.

In one embodiment audio is captured through the use of several microphones positioned to adequately capture the sound produced in a variety of different environments and circumstances related to the observation task. One embodiment uses an Audio Technica microphone wired into the microphone jack of the AXIS 214 PTZ. This microphone is intended to capture general environmental audio when the overall noise level is low. Two additional Philips VOIP841 phones are also included to capture audio that is generally louder or more complex. One of these phones is worn by the person being observed at the remote location. That individual wears a headset plugged into the worn phone to enable the remote observer to clearly hear everything said by that individual. The second phone is deployed like a wireless microphone with a short range; activating the speakerphone function allows the remote observer to hear all audio within a short range of the phone. Other audio reception means are known to those skilled in the art and could be implemented without departing from the spirit and scope of the present invention. The description of the embodiments of the present invention is not intended to limit the scope of the invention but is presented for purposes of illustration only and not limitation to describe the features and characteristics of the present invention.

In one embodiment of the invention the video and audio received by the remote observer can be recorded (301) for later playback and analysis. One means of recording the data is storing the audio and/or video data in a digital format. The audio/video capture allows the observer to record the video to local storage or to remote servers where it can be retrieved by authorized users. Numerous formats are known to those skilled in the art. The scope of the present invention is not intended to be limited to any one specific audio and/video capture means or format.

Metadata (109) can be captured alongside the video and audio data. Metadata refers to data generated by users (e.g., the observer) about the video and audio data. The data may include, for example, when, what, where, and who was observed and the comments, thoughts, and suggestions of the observer. These metadata are recorded (301) and can be retrieved synchronously with the video and audio data so that a user can see both the data and the metadata simultaneously. Metadata may take a variety of forms including but not limited to text entries, audio recordings of verbal comments, and formal observation protocols. One embodiment of the metadata capture process is a webpage divided into several sections and presented to the observer. One section of this webpage contains the live observation video (the data) while another section presents a text box for typing notes and a closed-ended observation form (the metadata). With this presentation format the observer can observe and record the data while simultaneously generating metadata. The “package” of data and metadata can then be retrieved at any time for analysis, communication, or further metadata generation.

In addition to being an observation system, the system and methods also enable communication between the observed and the observer. This communication may center on observation data, but can also relate in general to the ongoing change process resulting from the application of the cognitive apprenticeship model. Also, this communication may occur during video observation or later. One embodiment is the integration of a Philips VOIP841 phone. This technology enables normal telephone communication between the hardware platform and any other phone in the world over the internet.

Further, the system manages ancillary information incidental to the observation that can be generated before, during, or after the observation. Classroom-related examples of ancillary information may include sharing of lesson plans, and lesson-related materials (i.e. handouts, worksheets, video clips, Power Point slides, examples of student work) exchanged between the observer and observed.

The system and method also enables immediate performance feedback from the observer or observers (114, 201) to the person being observed. A Philips VOIP841 phone with a telephone headset worn by the observed allows the observer or observers to verbally coach the observed (100) as they are performing a behavior. The observer or observers (109) watch and listen to the audio and video produced by the hardware platform and delivered to an observer or observers. In one embodiment the information is delivered on a webpage. Based on those observations, the observer or observers (109) immediately communicate suggestions for performance improvement in real time to the person (100) being observed.

All of the interactions described above (e.g., operation of the hardware platform, delivery of audio and video, creation of metadata, initiating communication) may be managed in one embodiment through a web application. This web application also ensures that the users are authorized, that data delivery is secure, and enables the retrieval of all data and metadata. The web application allows for the scheduling and coordination of all of these activities. Numerous data management formats and solutions are known to those skilled in the art. The scope of the present invention is not intended to be limited to any one specific means or format.

The scheduling feature allows both the observer and the observed to enter their working schedule into a calendar online. This calendar is presented in a format that will be familiar to anyone that has used scheduling software. User can also identify times during which they are willing to participate in observations via IRIS. Once two users' schedules have been entered, the system can identify times when openings in the two users' schedules overlap. The system presents these times to the users, enabling them to invite the other user to participate in an observation. The scheduling feature also records and presents information for observations that have already taken place, giving users easy access to the data collected during those observations.

The remote observation system, among other things, enables cognitive apprenticeship. One component of cognitive apprenticeship is modeling, in which a trainer (an expert in a particular skill) models the performance of a skill for an apprentice. In one embodiment the remote observation system provides a technological framework for this activity and enables (single or multiple) apprentice(s) to observe the expert performing the skill from a remote location via a computer, internet connection, and a web browser. IN this embodiment the system enables these apprentices to communicate with the trainer in real-time, to record their observation notes and to generate other observational metadata.

### Example of System Operating as Training System for a Single Remote Observer

For example, a physical therapist in Montana (the trainee) desires help in improving her technique for post knee surgery patients. This physical therapist has enrolled for training with an experienced therapist in Los Angeles. The remote observation is installed in the facility in Montana. A training schedule is posted to the system. The expert in Los Angeles (the trainer) will observe the trainee in real time during some of the scheduled sessions. During these real time sessions the trainer communicates to the trainee and offers instruction while the trainee's patient is in therapy. In addition to the real time feedback from trainer to trainee the session is recorded and feedback is incorporated into the session for future review. During some the scheduled sessions the trainer is unavailable. The sessions are recorded and reviewed by the trainer at the trainer's convenience. Observation data is incorporated into the recording and then reviewed with the trainee independently or in discussion with the trainer at a mutually convenient time.

### Example of System Operating as a Training System for Multiple Remote Observers

For example, the physical therapist in the above example in Montana (the trainee) desires help in improving her technique for post knee surgery patients. This physical therapist has enrolled for training with an experienced therapist in Los Angeles. The remote observation is installed in the facility in Montana. A training schedule is posted to the system. An expert in exercise techniques in Los Angeles (the first trainer) and an expert in massage therapy in New York (the second trainer) will observe the trainee in real time during agreed upon scheduled sessions. During these real time sessions the trainers communicate to the trainee and each other while the trainee's patient is in therapy. In addition to the real time feedback from trainers to trainee the session is recorded and feedback is incorporated into the session for future review. The two trainers are able to collectively provide for enhanced training to the trainee by adding observations from their respective areas of expertise.

Example of System Operating as a Trainer Performing a Task with Trainees Observing

For example, a teacher in New York is an expert in teaching the mathematical concept of “place value”. This teacher has agreed to provide training to six other teachers from around the country (e.g., Texas, Utah, Alabama, Montana, Rhode Island, and Idaho). The trainer in New York enters her teaching schedule into the remote observation system, indicating that she will be teaching mathematics every Wednesday for the next three weeks. The six trainees from around the country log into the remote observation system, see this schedule, and schedule their time accordingly (e.g., arrange for a substitute teacher to take over their class during that time, arrange for a computer to use, etc.) At the first appointed Wednesday, the trainer places the remote observation hardware device in her classroom. The six trainees from around the country log into the remote observation system and begin watching and listening to the trainer as she models how to effectively teach place value. Each of the six trainees can sequentially control the camera system. In addition, each trainee can use the controls on their screen to take observation notes, complete an observation protocol, count observable behaviors, etc.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A method of observation of a subject performing behavior, comprising the steps of:
an observation system local to the subject observing the subject and producing local observation data;
said local observation data communicated to a remote receiving station,
displaying said local observation data at said remote receiving station;
generating feedback from an observer observing said displaying said local observation data at said remote receiving station; and
communicating said feedback to the subject.

2. The method of claim 1, wherein:
said feedback is communicated in real time.

3. The method of claim 1, wherein:
said feedback is generated in real time.

4. The method of claim 1, wherein:
said displaying said local observation data is in real time.

5. The method of claim 1, further comprising:
means of recording said observation data.

6. The method of claim 5, further comprising:
means for time correlating said feedback with said data; and
said recording means records said observation data and incorporates said feedback with said data and with said time correlation.

7. The method of claim 1, wherein:
said local observation data is transmitted to said remote receiving station via an intranet.

8. The method of claim 1, wherein:
said local observation data is transmitted to said remote receiving station via the internet.

9. The method of claim 1, wherein:
said local observation system is mobile.

10. The method of claim 1, wherein:
said observation data is transmitted and received by a secure system.

11. The method of claim 1, wherein:
said observation data is encrypted.

12. The method of claim 1, wherein:
said feedback is communicated via a voice communication system.

13. The method of claim 12, wherein:
said feedback is communicated via a built-in two-way phone.

14. The method of claim 12, wherein:
said feedback is communicated via a Voice over Internet phone.

15. The method of claim 14, wherein:
said feedback is communicated via a Skype phone.

16. The method of claim 1, wherein:
said feedback is communicated via text.

17. The method of claim 1, wherein:
said feedback is communicated via a graphical representation.

18. The method of claim 17, wherein:
said graphical representation includes a dashboard style indicator.

19. The method of claim 1, wherein:
said feedback is gathering data for research purposes.

20. The method of claim 1 further comprising:
said local observation data communicated to a second remote receiving station,
displaying said local observation data at said second remote receiving station in real time,
generating feedback from said second remote receiving station; and
communicating said feedback from said second remote receiving station to the subject.

21. The method of claim 1 further comprising:
means for scheduling observation of the subject.

22. A method of a trainer instructing a trainee performing behavior to be improved, comprising the steps of: a mobile observation system observing the trainee and transferring via the internet observation data to a remote receiving station;
displaying said transmitted observation data at said remote receiving station on an internet connected computer;
generating instruction at the said remote receiving station; and
communicating said instruction to the trainee.

23. The method of claim 22, wherein:
said instruction is communicated via electronically enabled audio communication.

24. The method of claim 23, wherein:
said instruction is communicated via a Voice over Internet phone.

25. The method of claim 22, further comprising:
means of recording said observation data at said remote receiving station.

26. The method of claim 25, further comprising:
means for time correlating said instruction with said data; and
said recording means records said observation data and incorporates said instruction with said data and with said time correlation.

27. A method of instruction, comprising the steps of:
observing a trainer performing instructional material with a mobile observation system local to the trainer observing said trainer; transferring observation data to a remote receiving station;
displaying said transmitted observation data at said remote receiving station on a computer so a trainee may observe it at said remote receiving station;
generating feedback; and
communicating said feedback to said remote receiving station from said mobile observation station.

28. The method of claim 27, wherein:
said communicating to said remote receiving station from said mobile observation station said feedback is via electronically enabled audio communication.

29. The method of claim 27 wherein:
said communicating to said remote receiving station from said mobile observation station said feedback is via a Voice over Internet phone.

30. The method of claim 27, further comprising:
means of recording said transmitted observation data at said remote receiving station;
means for time correlating said feedback with said observation data; and
said recording means records said observation data and incorporates said feedback with said data and with said time correlation.

31. An apparatus for remote observation, comprising:
a mobile audio and video observation system local to an observable generating audio and video data;
a remote receiving station;
an internet connection connecting said receiving station to said observation system;
data transfer protocols controlling transmission of said audio and video data from said mobile observation system to said remote receiving station;
an electronically enabled audio communication system;
data transfer protocols controlling transmission of audio data generated at said remote receiving station transmitted to said mobile observation system;
a computer at said remote receiving station controlling said data transfer protocols;
said computer controlling transmission of said audio and video data from said mobile observation system to said remote receiving station; and
said computer controlling transmission of audio data generated at said remote receiving station transmitted to said mobile observation system.

32. The apparatus of claim 31, further comprising:
a recording mechanism;
said recording mechanism receiving and recording said audio and video data from said observation system;
said recording mechanism receiving and recoding said audio data generated at said receiving station; and
said recording of said audio and video data from said observation system and said recoding of said audio data generated at said receiving station are time correlated.

33. The apparatus of claim 31, wherein:
said data transfer protocol controlling transmission of audio data generated at said remote receiving station transmitted to said mobile observation system is a Voice over Internet protocol.
